(19) United States
(12) Patent Application Publication
(10) Pub. No.: US 2026/0337991 A1
(43) Pub. Date: Oct. 29, 2026

(54) EROSION FEEDER FOR SWIMMING POOLS AND SPAS

(71) Applicant: Zodiac Pool Systems LLC, Carlsbad, CA (US)

(72) Inventors: Anthony Levacque, Carlsbad, CA (US); Mark J. Bauckman, San Marcos, CA (US); William Jones, Carlsbad, CA (US); Jason McGuire, Carlsbad, CA (US)

(73) Assignee: Zodiac Pool Systems LLC, Carlsbad, CA (US)

(21) Appl. No.: 19/654,374

(22) Filed: Apr. 21, 2026

Related U.S. Application Data
(60) Provisional application No. 63/793,778, filed on Apr. 24, 2025.

(51) Int. Cl. E04H 4/12

(52) U.S. Cl. CPC E04H 4/1281

(57) ABSTRACT

An erosion feeder for a swimming pool or spa is supplied with one or more tabs or pellets of disinfectant. As water flows through the erosion feeder and over the disinfectant tabs, the disinfectant tabs slowly dissolve, thereby adding the disinfectant to the water. The erosion feeder includes a sensing module, which may determine a level and/or an amount of one or more disinfectant tabs in the erosion feeder.

### REFERENCE TO RELATED APPLICATION

This application claims the benefit of and priority to U.S. Provisional Patent Application No. 63/793,778, filed on Apr. 24, 2025, and entitled TAB FEEDER FOR SWIMMING POOLS AND SPAS, the content of which is hereby incorporated by reference in its entirety.

### FIELD OF THE INVENTION

The invention relates to sanitization systems for swimming pools or spas, and more particularly, but not necessarily exclusively, to erosion feeders.

### BACKGROUND

Swimming pools, spas, hot tubs, and other water containing vessels (hereinafter “swimming pools or spas”) may include a sanitization system to help maintain water quality and thereby minimize issues for users of the swimming pools or spas as well as equipment of the swimming pools or spas. A common sanitization system includes an erosion feeder (also known as a tab feeder, tablet feeder, chlorinator, tablet chlorinator, or chemical feeder), which may be in-line with a flow of water or a floating device. Erosion feeders are supplied with one or more tabs or pellets of disinfectant (commonly chlorine or bromine), and as water flows through the erosion feeder and over the disinfectant tabs, the disinfectant tabs slowly dissolve, thereby adding the disinfectant to the water.

Conventional erosion feeders include a manual valve, and a user or pool professional must manually adjust the valve to adjust the disinfectant output and as determined by the user or pool professional. Such approaches rely on the expertise of the user or pool professional to predict the disinfectant needs of the body of water to properly set the manual valve, and as such conventional approaches are often inaccurate. Inaccurate readings may lead to under-dosing or over-dosing the disinfectant, potentially leading to a safety and/or health issue.

Moreover, conventional erosion feeders may run out of disinfectant tabs, but the user and/or pool professional generally does not know when disinfectant tabs have been used until the erosion feeder has been manually checked. As such, conventional approaches allow for erosion feeders to run out of disinfectant tabs, which can lead to health and/or safety issues as the water would not be disinfected. As such conventional approaches of maintaining water quality utilizing erosion feeders are often inaccurate, inconvenient, labor-intensive and time-consuming.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, an erosion feeder for a swimming pool or spa includes means for determining a level or amount of one or more disinfectant tabs in the erosion feeder.

According to various embodiments, an erosion feeder for a swimming pool or spa includes a sensing module for determining a level or amount of one or more disinfectant tabs in the erosion feeder.

According to some embodiments, an erosion feeder for a swimming pool or spa, the erosion feeder comprising one or more sensors for detecting a level or amount of disinfectant tabs in the erosion feeder.

In some embodiments, a method includes detecting a level or amount of disinfectant tabs in an erosion feeder and generating an output response based on the detected level or amount of disinfectant tabs.

According to various embodiments, a method includes receiving a measurement of a level or concentration of disinfectant in water of a swimming pool or spa, and automatically adapting a disinfectant output of an erosion feeder based on the received measurement.

In some embodiments, a non-transitory computer readable storage medium includes a plurality of instructions executable by one or more processors, the plurality of instructions comprising instructions which, when executed by the one or more data processors, cause the one or more data processors to perform actions including: detecting a level or amount of disinfectant tabs in an erosion feeder and generating an output response based on the detected level or amount of disinfectant tabs.

In certain embodiments, a non-transitory computer readable storage medium includes a plurality of instructions executable by one or more processors, the plurality of instructions comprising instructions which, when executed by the one or more data processors, cause the one or more data processors to perform actions including: receiving a measurement of a level or concentration of disinfectant in water of a swimming pool or spa and automatically adapting a disinfectant output of an erosion feeder based on the received measurement.

According to various embodiments, a pool system includes the erosion feeder inline with a flow of water from a pool or spa and/or as a floating device.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 illustrates a pool system with an erosion feeder according to embodiments.

FIG. 2 illustrates a portion of the pool system of FIG. 1 with the erosion feeder according to embodiments.

FIG. 3 is another view of a portion of the pool system of FIG. 1 with the erosion feeder according to embodiments.

FIG. 4 illustrates a method of controlling the pool system of FIG. 1 using the erosion feeder according to embodiments.

FIG. 5 illustrates another method of controlling the pool system of FIG. 1 using the erosion feeder according to embodiments.

### DETAILED DESCRIPTION

Described herein are erosion feeders and associated systems and methods for controlling water quality using disinfectant tabs. The erosion feeders described herein may utilize various types of disinfectant tabs as desired, such as but not limited to chlorine tabs and/or bromine tabs.

In various embodiments, the erosion feeders described herein include a sensing module with means for sensing and/or determining a level and/or amount of disinfectant tabs present in the erosion feeder and/or remaining in the erosion feeder. The sensing module may utilize various technologies as desired. In some embodiments, the sensing module may be electro-mechanical sensing technologies. In certain embodiments, the sensing module may utilize various non-intrusive techniques, and the sensing module may sense and/or determine the level and/or amount of disinfectant tabs without being physically present within a receiving area housing the disinfectant tabs (which may be harsh due to high disinfectant concentration). In non-limiting examples, the sensing module may utilize various sensing means or techniques such as, but not limited to, capacitive sensing, ultrasonic level sensing, weight sensing, optical sensing, combinations thereof, and/or other sensing technologies as desired.

Regardless of the particular sensing means utilized to sense and/or determine the disinfectant tabs, in certain embodiments, the erosion feeders described herein may generate various output responses based on the detected level or amount of disinfectant tabs. In some embodiments, the output response may include providing the disinfectant tab level information, an estimated disinfectant consumption, a low tab level, a refill reminder, and/or other associated information based on the disinfectant tab level to a user on a user interface and/or a remote device. In certain embodiments, the output response may include controlling a valve and/or other flow control means to control the disinfectant output of the erosion feeder. In various embodiments, the output response may include providing the tab level and/or other associated information to another system of the pool system. Other output responses may be generated as desired.

In some embodiments, the systems and methods described herein may include an erosion feeder with a local (e.g., onboard) control system. In such embodiments, the erosion feeder may receive information regarding a concentration and/or level of disinfectant in the swimming pool or spa and may automatically adjust the disinfectant output of the erosion feeder based on the received information.

Compared to traditional erosion feeders, the erosion feeders described herein may provide improved and accurate control of water quality utilizing disinfectant tabs and further without the labor and time requirements of conventional approaches. In some embodiments, the erosion feeders may minimize and/or prevent erosion feeders from running out disinfectant tabs by monitoring the tab level and providing the tab level information to relevant users and/or systems. The erosion feeders described herein may also automatically adjust the disinfectant output based on actual measurements from the pool or spa. Various other benefits and advantages may be realized with the systems, devices, and methods provided herein, and the aforementioned advantages should not be considered limiting.

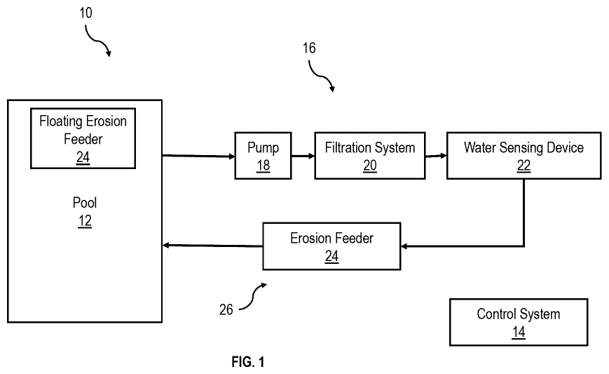

FIG. 1 illustrates an example of a pool system 10 according to embodiments. The pool system 10 generally includes a swimming pool or spa 12 (hereinafter “pool 12”) and a sanitization system 26 with an erosion feeder 24 for controlling water quality of water of the pool 12 as described in greater detail below.

The pool 12 may have various features, arrangements, shapes, and profiles as desired, and the particular pool 12 illustrated should not be considered limiting. In some embodiments, the pool 12 includes a circulation system 16 for circulating water and/or performing various actions for controlling the water quality of the water of the pool 12. In certain embodiments, the circulation system 16 includes one or more pumps 18 and a filtration system 20.

Optionally, the pool system 10 includes a water sensing device 22 for measuring one or more water parameters of water of the pool 12. In some embodiments, the water sensing device 22 is in-line with other equipment of the pool system 10. As a non-limiting example and as illustrated in FIG. 1, the water sensing device 22 may be provided in-line with the circulation system 16. However, in other embodiments, the water sensing device 22 may be provided in-line with other systems and/or provided at other locations within the pool system 10 and relative to other equipment as desired. As non-limiting examples, the water sensing device 22 may be a handheld device, a device within the pool 12, a floating device, combinations thereof, and/or other types of devices as desired.

The water sensing device 22 may measure one or more water parameters of the pool water. As non-limiting examples, the one or more water parameters measured by the water sensing device 22 may include, but are not limited to, pH, ORP, free chlorine, total chlorine, total alkalinity, cyanuric acid concentration, water temperature, water flow, and/or other parameters. In one non-limiting example, the water sensing device 22 may measure information related to disinfectant concentration and/or level in the water of the pool 12. The water sensing device 22 thus may be various types of devices suitable for obtaining the measurements as desired. As non-limiting examples, the water sensing device 22 may be a probe-based device, a colorimetric sensing device, an amperometric sensor, an electrochemical sensing device, combinations thereof, and/or other water sensing devices as desired.

Optionally, the pool system 10 includes a control system 14. The control system 14 may include one or more processing units and/or memory devices and is communicatively coupled to one or more components of the pool system 10 and/or to remote devices and/or systems as desired. The control system 14 may be local to or remote from the pool system 10 as desired. As non-limiting examples, in some embodiments, the control system 14 (or components thereof) may be remote from the pool system 10 and may be internet-based, in the cloud, at another physical location, combinations thereof, and/or as otherwise desired. Additionally, or alternatively, the control system 14 (or components thereof) may be provided locally as a stand-alone system and/or component of another device and/or system. As a non-limiting example, FIG. 1 illustrates the control system 14 as a stand-alone system. However, in other embodiments, one or more components of the control system 14 may be implemented as a stand-alone device, locally onboard a component of the circulation system 16 and/or the water sensing device 22, combinations thereof, and/or as otherwise desired. Other configurations of the control system 14 may be implemented as desired.

The one or more processing units of the control system 14 may be any suitable processing device or combinations of devices including but not limited to one or more application specific integrated circuits, digital signal processors, digital signal processing devices, programmable logic devices, field programmable gate arrays, processors, controllers, micro-controllers, microprocessors, other electronic units, and/or a combination thereof. The one or more memory devices of the control system 14 may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory, random access memory, magnetic random access memory, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data.

In various embodiments, the control system 14 may include one or more communication modules such that the control system 14 is communicatively coupled to components of the pool system 10 and/or other systems or devices as desired such that the control system 14 may send and/or receive information with other components. As non-limiting examples, the control system 14 may be communicatively coupled to a user device, the pump 18, the filtration system 20, the water sensing device 22, and/or the erosion feeder 24. Non-limiting examples of communication modules may include systems and mechanisms enabling wired communication and/or wireless communication (e.g., near field, cellular, Wi-Fi, Bluetooth®, Bluetooth Low Energy (BLE), low-power wide area network, cloud-based communication etc.).

As mentioned, the sanitization system 26 includes one or more erosion feeders 24 which utilize disinfectant tabs or pellets for controlling the water quality of water of the pool 12. In some embodiments, and as illustrated in FIG. 1, the erosion feeder 24 may be provided in-line with the circulation system 16. In other embodiments, the erosion feeder 24 may be provided at other locations within the pool system 10 and/or relative to other equipment as desired. In one non-limiting example, the erosion feeder 24 may be buoyant and/or adapted to float within the pool 12 as illustrated in FIG. 1.

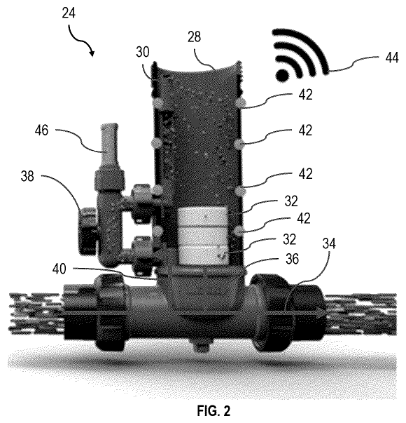

Referring to FIG. 2, the erosion feeder 24 generally includes a housing 28 defining a receiving area 30 for receiving one or more disinfectant tabs 32. The disinfectant tabs 32 may be various types of disinfectant tabs as desired. In non-limiting examples, the disinfectant tabs 32 may be chlorine tabs and/or bromine tabs. The particular size and shape of the receiving area 30 and/or number of disinfectant tabs 32 within the receiving area 30 should not be considered limiting. Water flowing through the erosion feeder 24 (represented by arrow 34) may slowly dissolve the disinfectant tabs 32, thereby adding the disinfectant to the water 34 (represented by arrow 36).

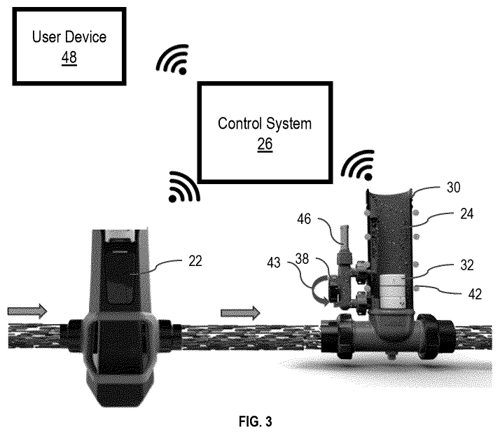

In various embodiments, the erosion feeder 24 includes a flow control device 38 for controlling a flow of water into the receiving area 30 (represented by arrow 40) and thus the rate and/or amount at which the disinfectant tabs 32 dissolve as a disinfectant output. The flow control device 38 is adjustable (represented by arrows 43 in FIG. 3) and may be various suitable devices for controlling the flow of water. In some non-limiting examples, the flow control device 38 includes one or more valves. As described in detail below, the flow control device 38 optionally may be automatically controlled to control the disinfectant output. Additionally, or alternatively, the flow control device 38 may be manually actuated as desired.

As illustrated in FIG. 2, the erosion feeder 24 includes a sensing module 41 with means for sensing or detecting a level or amount of the one or more disinfectant tabs 32 in the erosion feeder 24. In some embodiments, the sensing module 41 includes one or more sensors 42 provided at various locations on, within, and/or relative to the erosion feeder 24 as desired. The one or more sensors 42 may utilize various sensing technologies (or combinations thereof) for measuring or detecting the level or amount of the one or more disinfectant tabs 32 in the erosion feeder 24. As non-limiting examples, the one or more sensors 42 may be one or more capacitive sensors, one or more ultrasonic level sensors, one or more weight sensors, one or more optical sensors, one or more cameras, combinations thereof, and/or other sensors as desired. In a non-limiting example, the one or more sensors 42 may be an electro-mechanical sensor.

Optionally, the one or more sensors 42 are non-intrusive sensors capable of measuring or detecting the level and/or amount of the disinfectant tabs 32 in the receiving area 30 without being exposed to the water of the receiving area 30. In such embodiments, the non-intrusive sensors 42 may obtain the measurements without being exposed to the relatively harsh environment within the receiving area 30 due to the concentration of the disinfectant (e.g., chlorine levels). As such, a “non-intrusive” sensor refers to one that is not physically positioned within the receiving area while still being capable of detecting the level and/or amount of the disinfectant tab. In other embodiments, optionally dependent on the type of sensor 42, the sensor 42 may be provided at various locations as desired and need not be a non-intrusive sensor.

In certain embodiments, the erosion feeder 24 includes devices, components, and/or systems for receiving and/or providing data such as the disinfectant tab level and/or associated information to a user and/or another system. As non-limiting examples, the erosion feeder 24 optionally may include a user interface on or associated with the erosion feeder 24. Additionally, or alternatively, the erosion feeder 24 may include a communication module enabling wired or wireless communication 44 between the erosion feeder 24 and a remote device, such as but not limited to a handheld device, user device, phone, computer, tablet, combinations thereof, and/or other remote devices as desired via various communication techniques. In one non-limiting example, and as illustrated in FIG. 3, the erosion feeder 24 may include a communication module enabling wireless communication between the erosion feeder 24 and an application running on a user device 48, another system of the pool system 10 such as but not limited to the water sensing device 22, and/or a control system 14 of the pool system 10. As non-limiting examples, and with reference to FIG. 3, the erosion feeder 24 may communicate directly or indirectly with the control system 14, the water sensing device 22, and/or the user device 48. In some embodiments, the erosion feeder 24 optionally may indirectly communicate with another component. As a non-limiting example and as illustrated in FIG. 3, the erosion feeder 24 may indirectly communicate with the water sensing device 22 (e.g., to obtain a water parameter measurement) via the control system 14 and/or may indirectly communicate with the user device 48 (to provide a disinfectant tab level or other information) via the control system 14. Other communication techniques may be utilized by the erosion feeder 24 as desired, and the aforementioned examples should not be considered limiting.

Optionally, the erosion feeder 24 includes a local or onboard control system 26. Components of the control system 26 may be similar to the control system 14 and/or the control systems 14, 26 may be the same and/or components of the same system, although they need not be in other embodiments. In certain embodiments, the control system 26 may be communicatively coupled with the one or more sensors 42 and/or the flow control device 38. Optionally, the communication module of the erosion feeder 24 may be a component of the control system 26.

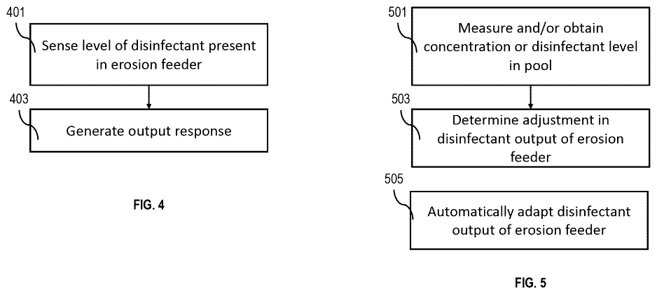

Various methods may be implemented in the pool system 10 using the erosion feeder 24. FIGS. 4 and 5 illustrate two non-limiting examples of control by the erosion feeder 24. However, other techniques may be utilized as desired. The methods (and/or sub-steps thereof) may be performed by various components. Optionally, one or more steps may be performed by the control system 26 and/or the control system 14.

Referring to FIG. 4, a method of controlling a disinfectant level (e.g., chlorine, bromine, etc.) may include sensing the level or amount of disinfectant present within the erosion feeder 24 in a block 401. In certain embodiments, block 401 includes sensing the level or amount of disinfectant utilizing the one or more sensors 42. In non-limiting examples, block 401 includes measuring the level of the disinfectant tabs 32 using a capacitive sensor, an ultrasonic level sensor, a weight sensor, an optical sensor, combinations thereof, and/or other suitable sensors as desired.

In a block 403, the method includes generating an output response based on the level or amount measured in block 401.

Optionally, block 403 includes estimating or predicting a consumption of the disinfectant as the output response. In a non-limiting example, block 403 includes estimating a chlorine consumption when chlorine is the disinfectant.

In some embodiments, block 403 includes providing an alert or notification of the amount of disinfectant left in the erosion feeder 24, a level of the disinfectant tabs 32 in the erosion feeder 24, a low tab level, a refill reminder, and/or other information associated with the level or amount of disinfectant tabs 32. In some embodiments, block 403 includes providing the alert or notification on a user interface of the erosion feeder 24. Additionally, or alternatively, block 403 may include providing the alert or notification by communicating (directly or indirectly) with the user device 48. In a non-limiting example, block 403 includes generating the alert or notification via an application running on the user device 48. Optionally, block 403 may include providing the alert or notification to another system or device of the pool system 10.

In some embodiments, block 403 includes controlling the flow control device 38 as the output response. As a non-limiting example, block 403 may include controlling the flow control device 38 such that the disinfectant output is reduced based on an estimated disinfectant consumption being greater than a desired disinfectant consumption (e.g., as set by the user, predetermined, and/or determined by the pool system 10).

Various other output responses (and combinations thereof) may be generated in block 403 based on the sensed level of disinfectant, and the aforementioned examples should not be considered limiting.

Referring to FIG. 5, a method of controlling a disinfectant level (e.g., chlorine, bromine, etc.) may include measuring and/or obtaining a measurement of a concentration or level of disinfectant in water of the pool 12 in a block 501. In some embodiments, block 501 includes obtaining the measurement directly or indirectly from the water sensing device 22. In a non-limiting example, block 501 includes obtaining the measurement from a probe-based device, a colorimetric sensing device, an amperometric sensor, and/or an electrochemical device. The water parameter measurement may directly or indirectly provide the disinfectant level or amount. As a non-limiting example where the disinfectant is chlorine, block 501 may include obtaining a free chlorine measurement and/or an ORP measurement.

In a block 503, the method includes determining any adjustment in the disinfectant output from the erosion feeder 24 based on the measurement obtained in block 501. Optionally, block 503 includes determining that no adjustment is needed and/or the disinfectant output from the erosion feeder 24 should be maintained. Additionally, or alternatively, block 503 includes determining a change in the disinfectant output based on the measurement obtained in block 501 being above and/or below a desired level or threshold. As a non-limiting example, based on a chlorine measurement obtained in block 501 being less than a desired level or threshold, block 503 may include determining an increase in chlorine output from the erosion feeder 24.

In a block 505, the method includes controlling the flow control device 38 to adjust the disinfectant output from the erosion feeder 24 based on the determination in block 503. As a non-limiting example, based on block 503 determining that an increase in chlorine output is needed from the erosion feeder 24, block 505 may include controlling the flow control device 38 to increase the flow of water through the receiving area 30 to increase the chlorine output from the erosion feeder 24. Various other controls of the erosion feeder 24 may be generated in block 505 based on the sensed level of disinfectant in the water of the pool 12, and the aforementioned examples should not be considered limiting.

The systems and methods described herein thus provide automatic, accurate, and reliable measurement of disinfectant tabs in an erosion feeder and associated control based on such measurements. In certain embodiments, the disinfectant tab measurements may be provided to a consumer or professional locally on the monitoring device itself and/or remotely as desired, such as but not limited to via an app. In certain embodiments, the erosion feeders described herein may reduce and/or eliminate the need for physical involvement by a consumer or professional to physically go to the erosion feeder to determine the level of disinfectant tabs and/or the disinfectant output response. Various other benefits and advantages may be realized with the systems, devices, and methods provided herein, and the aforementioned advantages should not be considered limiting.

Exemplary concepts or combinations of features of the invention may include:
A. An erosion feeder for a swimming pool or spa, the erosion feeder comprising means for determining a level or amount of one or more disinfectant tabs in the erosion feeder.
B. An erosion feeder for a swimming pool or spa, the erosion feeder comprising a sensing module for determining a level or amount of one or more disinfectant tabs in the erosion feeder.
C. An erosion feeder for a swimming pool or spa, the erosion feeder comprising one or more sensors for detecting a level or amount of disinfectant tabs in the erosion feeder.
D. A method comprising detecting a level or amount of disinfectant tabs in an erosion feeder and generating an output response based on the detected level or amount of disinfectant tabs.
E. A method comprising:
   i. receiving a measurement of a level or concentration of disinfectant in water of a swimming pool or spa; and
   ii. automatically adapting a disinfectant output of an erosion feeder based on the received measurement.
F. A non-transitory computer readable storage medium comprising a plurality of instructions executable by one or more processors, the plurality of instructions comprising instructions which, when executed by the one or more data processors, cause the one or more data processors to perform actions including:
   i. detecting a level or amount of disinfectant tabs in an erosion feeder; and
   ii. generating an output response based on the detected level or amount of disinfectant tabs.
G. A non-transitory computer readable storage medium comprising a plurality of instructions executable by one or more processors, the plurality of instructions comprising instructions which, when executed by the one or more data processors, cause the one or more data processors to perform actions including:
   i. receiving a measurement of a level or concentration of disinfectant in water of a swimming pool or spa; and
   ii. automatically adapting a disinfectant output of an erosion feeder based on the received measurement.
H. A pool system comprising the erosion feeder of any preceding or subsequent statement or combination of statements inline with a flow of water from a pool or spa.
I. A pool system comprising the erosion feeder of any preceding or subsequent statement or combination of statements as a floating device.
J. The erosion feeder, method, or instructions of any preceding or subsequent statement or combination of statements, wherein the disinfectant tabs comprise chlorine tabs and/or bromine tabs.
K. The erosion feeder, method, or instructions of any preceding or subsequent statement or combination of statements, wherein the sensor comprises an electro-mechanical sensor.
L. The erosion feeder, method, or instructions of any preceding or subsequent statement or combination of statements, wherein the sensor is non-intrusively provided into a receiving area of the erosion feeder configured to receive the one or more disinfectant tabs.
M. The erosion feeder, method, or instructions of any preceding or subsequent statement or combination of statements, wherein the sensor comprises one or more of a capacitive sensor, an ultrasonic sensor, a weight sensor, an optical sensor, combinations thereof, and/or other sensors as desired.
N. The erosion feeder, method, or instructions of any preceding or subsequent statement or combination of statements, wherein the erosion feeder is configured to provide an alert or notification comprising the detected level or amount as the output response.
O. The erosion feeder, method, or instructions of any preceding or subsequent statement or combination of statements, wherein the erosion feeder is configured to provide the alert or notification to a remote device or on a user interface of the erosion feeder.
P. The erosion feeder, method, or instructions of any preceding or subsequent statement or combination of statements, wherein the alert or notification comprises at least one of an estimated disinfectant consumption and/or a tab level.
Q. The erosion feeder, method, or instructions of any preceding or subsequent statement or combination of statements, wherein the measurement of the level or concentration of the disinfectant in the water of the swimming pool or spa is obtained from a probe-based device, a colorimetric sensing device, an amperometric sensor, an electrochemical sensing device, combinations thereof, and/or other water sensing devices as desired.
R. The erosion feeder, method, or instructions of any preceding or subsequent statement or combination of statements, wherein the erosion feeder is configured to directly or indirectly obtain the measurement of the level or concentration of the disinfectant in the water of the swimming pool or spa from a water sensing device.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with swimming pools or spas, persons skilled in the relevant field will recognize that the present invention conceivably could be employed in connection with other water containing vessels and in other manners, particularly but not limited to underwater installations. Finally, references to “pools” and “swimming pools” herein may also refer to spas or other water containing vessels used for recreation, training, or therapy.

As used herein, the meaning of “a,” “an,” and “the” includes singular and plural references unless the context clearly dictates otherwise.

The subject matter of embodiments of the present disclosure is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. A zero angle refers to an angle of 0° or 180°. Directional references such as “up,” “down,” “top,” “bottom,” “left,” “right,” “vertical,” “horizontal,” “lateral,” “longitudinal,” “front,” and “back,” among others, are intended to refer to the orientation as illustrated and described in the figure (or figures) to which the components and directions are referencing.

The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. An erosion feeder for a swimming pool or spa, the erosion feeder comprising a sensing module configured to determine a level or amount of one or more disinfectant tabs in the erosion feeder.

2. The erosion feeder of claim 1, wherein the sensing module comprises one or more sensors.

3. The erosion feeder of claim 1, wherein the erosion feeder comprises a receiving area configured to receive the one or more disinfectant tabs.

4. The erosion feeder of claim 3, wherein the sensing module comprises at least one sensor configured to determine the level or amount of the one or more disinfectant tabs in the receiving area without being positioned within a receiving area.

5. The erosion feeder of claim 1, wherein the one or more disinfectant tabs comprise one or more chlorine tabs and/or one or more bromine tabs.

6. The erosion feeder of claim 1, further comprising a control system, wherein the control system is configured to generate an output response based on the detected level or amount of disinfectant tabs.

7. The erosion feeder of claim 1, wherein the erosion feeder is a floating erosion feeder.

8. A method comprising:
detecting a level or amount of one or more disinfectant tabs in an erosion feeder; and
generating an output response based on the detected level or amount of disinfectant tabs.

9. The method of claim 8, wherein the erosion feeder comprises a sensing module configured to detect the level or amount of the one or more disinfectant tabs in the erosion feeder.

10. The method of claim 8, wherein detecting the level or amount of the one or more disinfectant tabs comprises detecting the level or amount with a sensor positioned relative to a receiving area of the erosion feeder such that the sensor detects the level or amount without being physically positioned within the receiving area.

11. The method of claim 8, wherein generating the output response comprises generating an alert or notification on a remote device or on a user interface of the erosion feeder.

12. The method of claim 11, wherein the alert or notification comprises at least one of an estimated disinfectant consumption and/or a tab level.

13. The method of claim 8, wherein detecting the level or amount of one or more disinfectant tabs in the erosion feeder comprises detecting the level or amount of one or more chlorine tabs and/or bromine tabs.

14. The method of claim 8, wherein detecting the level or amount of one or more disinfectant tabs in the erosion feeder comprises detecting the level with one or more electro-mechanical sensors.

15. The method of claim 14, further comprising obtaining a measurement of a level or concentration of disinfectant in the water from a water sensing device.

16. A non-transitory computer readable storage medium comprising a plurality of instructions executable by one or more processors, the plurality of instructions comprising instructions which, when executed by the one or more data processors, cause the one or more data processors to perform actions including:
detecting a level or amount of disinfectant tabs in an erosion feeder; and
generating an output response based on the detected level or amount of disinfectant tabs.

17. The non-transitory computer readable storage medium of claim 16, wherein the plurality of instructions further comprise instructions for generating an alert or notification on a remote device or on a user interface of the erosion feeder.

18. The non-transitory computer readable storage medium of claim 16, wherein the alert or notification comprises at least one of an estimated disinfectant consumption and/or a tab level.

19. The non-transitory computer readable storage medium of claim 16, wherein detecting the level or amount comprises utilizing a sensor module configured to determine a level or amount of one or more disinfectant tabs in the erosion feeder.

20. The non-transitory computer readable storage medium of claim 16, wherein detecting the level or amount comprises utilizing a sensor positioned relative to a receiving area of the erosion feeder such that the sensor detects the level or amount without being physically positioned within the receiving area.

21. The non-transitory computer readable storage medium of claim 16, wherein the plurality of instructions further comprise instructions for obtaining a measurement of a level or concentration of disinfectant in the water from a water sensing device.
